(19) United States
(12) Patent Application Publication
(10) Pub. No.: US 2021/0388818 A1
(43) Pub. Date: Dec. 16, 2021

(54) TOWERS COMPRISING A MAST

(71) Applicant: ALIMAK GROUP MANAGEMENT AB, STOCKHOLM (SE)

(72) Inventor: Jesús Angel COLOMA CALVO, LA MUELA (ES)

(21) Appl. No.: 17/283,531

(22) PCT Filed: Oct. 8, 2019
(86) PCT No.: PCT/EP2019/077241

§ 371 Date: Apr. 7, 2021

(30) Foreign Application Priority Data
Oct. 9, 2018 (EP) 18382716.1

(51) Int. Cl. F03D 13/20; F03D 13/10

(52) U.S. Cl. CPC F03D 13/20; F05B 2240/912; F03D 13/10

(57) ABSTRACT

A tower is provided comprising a first tower section having an upper flange, and a lower flange, a tower wall and a mast. The mast comprises a ladder and the mast is not attached to the tower wall. Also provided are methods for installing masts in a tower.

This application claims the benefit of European Patent Application EP18382716 filed on Oct. 9, 2018.

The present disclosure relates to towers. The present disclosure further relates to methods for installing a mast in a tower.

### BACKGROUND ART

Modern wind turbines are commonly used to supply electricity into the electrical grid. Wind turbines generally comprise a rotor mounted on top of a wind turbine tower, the rotor having a rotor hub and a plurality of blades. The rotor is set into rotation under the influence of the wind on the blades. The operation of the generator produces the electricity to be supplied into the electrical grid.

Towers may be constituted by cylinder-shaped or frustoconical sections which are mounted on top of each other. In the case of e.g. wind turbines, a plurality of contiguous stacked sections may be welded together and/or joined through flanges (or the like) to form an entire tower. Tower sections may be found in both steel and concrete wind turbine towers.

Typically, the wind turbine tower comprises an interior with components such as power and communication cables for transmitting electric power and signals from or to the generator. Service elevators with rigid rails or guiding wires, illumination means inside the tower, service platforms and ladders may be provided as well. All those components may be welded or bolted to the tower sections at several intermediate points along the section, which can reduce the fatigue resistance of the tower. Thus, the thickness of the walls of the sections may have to be increased to meet fatigue resistance requirements.

Furthermore, the tower sections may have connectors along their length to attach the components or auxiliary structures. The presence of the connectors both increases the complexity and slows down the manufacturing process.

The above mentioned components are attached to the tower along the inner wall of the tower sections. Therefore, the components have to adapt to the shape of the inner wall even if the interior of the tower has a slope. This affects the ladders and the service elevators. Elevators are usually arranged in such a way that a distance for evacuation purposes from the elevator to the ladder is less than a predefined value. This way, a person inside the elevator can relatively easily leave the cabin of the elevator towards the ladder in case of a malfunction of the elevator.

As the ladder is attached to the inner wall, the ladder has to follow the profile of the tower wall even if the wall has a slope or tilt. In order to keep the distance for evacuation purposes, the elevator path must in those cases be adapted to follow the ladder path. The latter may imply forcing the elevator path to a certain degree, e.g. by adopting a slope or twisted configuration, so that the guiding elements (taut cables) of the elevator can become unstable and less reliable over the product lifecycle

In some known solutions, particularly when the tower walls have a slope, the ladders can be installed by sections which are defined between a series of platforms. This way, each section of the ladder can keep an upright direction, i.e. not slanted with respect to an axial direction of the tower, while meeting the minimum safety distance between ladder and tower wall. However, the resulting ladder is not continuous which means that the ladder cannot provide a straight and vertical evacuation path. At each platform a trapdoor has to be provided and the user has to open it on the way down. Moreover, along the height of the tower, the distance between the elevator cabin and the ladder may vary, which can lead to more complicated evacuation or rescue operations.

The present disclosure provides examples of ladders, towers and methods that at least partially resolve some of the aforementioned disadvantages. Even though specific reference is made to wind turbine towers, and the systems herein described may be specifically suitable for wind turbine towers, it should be clear that implementations in other towers are also foreseen.

### SUMMARY

In a first aspect, a tower is provided. The tower comprises a first tower section having an upper flange, and a lower flange, a tower wall and a mast, wherein the mast comprises a ladder, and the mast is not attached to the tower wall.

The tower may comprise a first tower section having an upper flange, a lower flange, and a tower wall, and a mast. The mast may comprise a ladder and the mast may comprise a top end and a bottom end, the top end being connected to the upper flange or a service platform, and the bottom end being connected to the lower flange, so that the mast is not attached to the tower wall.

According to this aspect, a tower is obtained with a mast which does not need intermediate connections to the tower sections, so there may be no affection of the fatigue resistance of the tower.

As there are no intermediate connections, connectors on the inner walls of tower sections are not required. The tower section according to such an aspect can be produced much quicker than the known solutions. Particularly for tower sections made from steel, the section may be released from welding rollers station and moved to the painting cabin much earlier, which turns out in a better utilization of the tower factory manufacturing capacity.

In one example, the mast may be connected to the upper and lower flange of the tower section. In another example, the mast may be connected to the upper flange through the platform and to the lower flange. Therefore, in those examples the mast is not attached to the tower wall. The mast is not directly attached nor supported in any way to the tower wall. Furthermore, the tower does not have any intermediate connections between the mast and the tower wall.

The mast of the tower may be arranged in substantially upright position along the tower, and the mast of the tower may be integrated in parallel to a service elevator so there is no need for the elevator to adapt to the slope of the tower wall or twist throughout the path. The ladder may be arranged substantially upright so the service elevator may travel upwards or downwards in a substantially fully vertical direction while keeping the distance for evacuation purposes. The elevator path does not have to adopt a slope or twisted configuration to keep the appropriate distance to the ladder. The elevator system including e.g. taut guiding cables may thus be more stable and reliable.

The mast of the tower may be a continuous mast, so it will provide a straight and vertical evacuation path. Trapdoors in platforms floors may be replaced with guard-rails installed in the mast, thereby removing an obstacle from the evacuation path. The evacuation can therefore be quicker and safer.

The mast of the present disclosure may be used for concrete and steel towers or even for a combination thereof.

In some examples of the tower, the mast may be supported by the upper and the lower flange (and not at any point along the wall between these flanges). Therefore, a semi-floating mast may be obtained with respect to the tower.

In some examples, the tower may further comprise a number of brackets to support the mast to a service platform, wherein a bracket comprises a body configured to surround, at least partially, the cross section of the ladder. Thus, the brackets may carry vertical loads from the mast and the lowermost part of the mast does not have to withstand with all the weight of the mast. The dimensions of the lowermost part of the mast may thereby be reduced.

In some examples, the tower may be a wind turbine tower.

In another further aspect, a method for installing a mast on a tower according to any of the herein disclosed examples is provided. The method comprises assembling a number of mast modules one after the other, and connecting the mast to an upper or lower flange of the tower.

The method for installing a mast on a tower may comprise assembling a number of mast modules one after the other; connecting a top end of the mast to an upper flange or a service platform and a bottom end of the mast to a lower flange of the tower section.

Thanks to this method, there is no need for intermediate connections between the mast and the tower walls so an easier installation of the mast than the known solutions may be obtained. Thus, a time and cost saving method may be achieved.

In some examples of the method where the tower section is made from steel, the method may further comprise: providing a tower section in a horizontal arrangement; detachably coupling a support beam to a flange and detachably coupling a mast module to the support beam. In such a case, the operators can install the mast in horizontal arrangement such as on the ground. The operators do not need to work at a height and need to be lifted to this height so they can work in safer conditions.

In some examples, the method may further comprise: introducing a mast module into the tower section when the module is in a folded configuration; moving away the ladder beams from each other so that the mast module may adopt an expanded configuration. As the mast modules are foldable, the logistic and handling during their installation is easier.

Throughout the present disclosure, expressions such as above, below, beneath, under, upper, top, bottom, lower, etc are to be understood taking into account the construction of an elevator or the like in an operating condition as a reference.

### DESCRIPTION OF THE DRAWINGS

Non-limiting examples of the present disclosure will be described in the following, with reference to the appended drawings, in which:

FIG. 1 schematically illustrates a view of one example of a wind turbine;

FIG. 2 schematically illustrates a longitudinal section view in perspective of a tower section of the wind turbine of FIG. 1 with a portion of mast according to one example;

FIG. 3 schematically illustrates a partial view of the tower section of FIG. 2 from a different perspective;

FIG. 4 schematically illustrates a side view of the tower section of FIG. 2;

FIGS. 5A-5C schematically illustrate cross-section views of a tower section with different relative arrangements of mast and elevator;

FIGS. 6A-6G schematically illustrate several positions of a mast module of the tower according to an example from expanded configuration to folded configuration;

FIG. 7 schematically illustrates a partial view of a tower section with a platform and a mast of FIG. 2;

FIG. 8 schematically illustrates a partial view of a tower section of FIG. 2 with a mast and a support beam;

FIG. 9 schematically illustrates a partial view of a tower section with a mast and a support beam of FIG. 8 from a different perspective;

FIGS. 10-14 schematically illustrate several steps for installing a portion of mast on a tower section according to an example;

FIG. 15 schematically illustrates a portion of mast being introduced into a tower section according to a further example; and

FIG. 16 schematically illustrates a partial view of a mast disposed through two different tower sections according to yet another example.

### DETAILED DESCRIPTION

In these figures, the same reference signs have been used to designate matching elements. Some parts have not been illustrated for the sake of clarity.

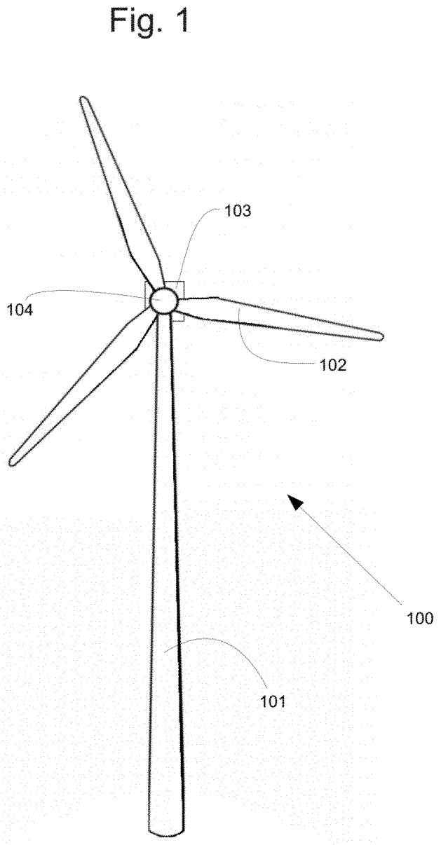

FIG. 1 schematically illustrates a view of one example of a wind turbine 100. As shown, the wind turbine 100 comprises a tower 101, a nacelle 103 mounted on the tower 101, a hub 104 coupled to the nacelle 103 and some blades 102 coupled to the hub 104. Inside the nacelle 103 a generator can produce electrical energy as will be apparent to those skilled in the art. Power and communication cables for transmitting electric power and signals from or to the generator may run through the interior of the tower 101.

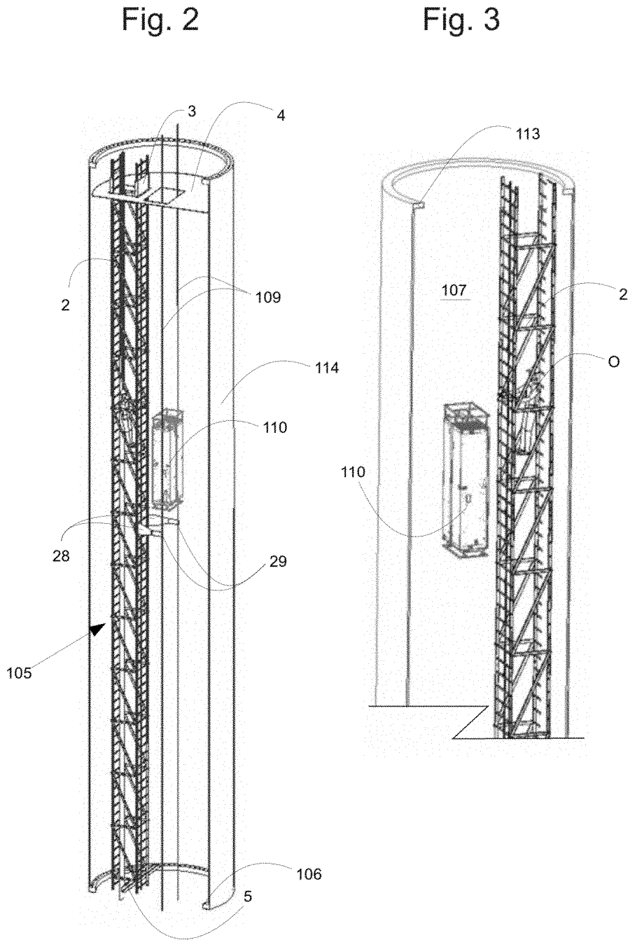

FIG. 2 schematically illustrates a longitudinal section view in perspective of a tower section 105 of the wind turbine 100 of FIG. 1 with a portion of mast 2 according to one example. FIG. 3 schematically illustrates a partial view of the tower section 105 of FIG. 2 from a different perspective.

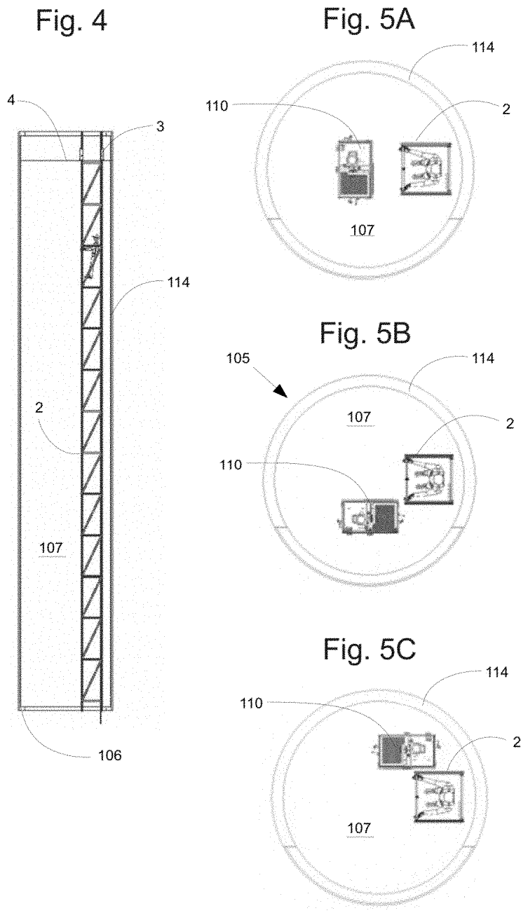

FIG. 4 schematically illustrates a side view of the tower section 105 of FIG. 2.

The tower 101 may be made from a plurality of tower sections 105 on top of each other. The tower sections 105 may be cylindrical, frusto-conical, or generally ring-shaped.

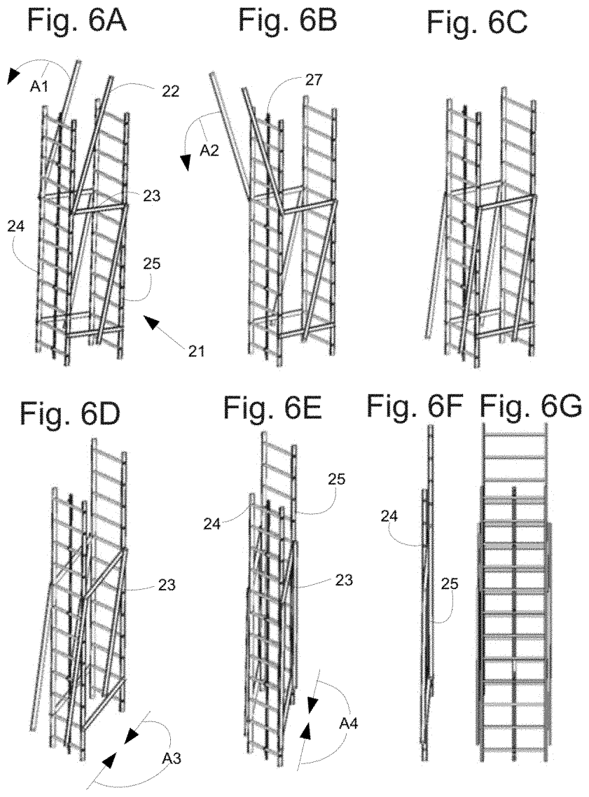

According to an aspect, an example of tower 101 is provided. The tower 101 comprises a first tower section 105, having an upper flange 113, and a lower flange 106, a tower wall 114, and a mast 2. The mast 2 comprises a ladder 24, 25 (see e.g. FIG. 6). And the mast 2 is not attached to the tower wall 114.

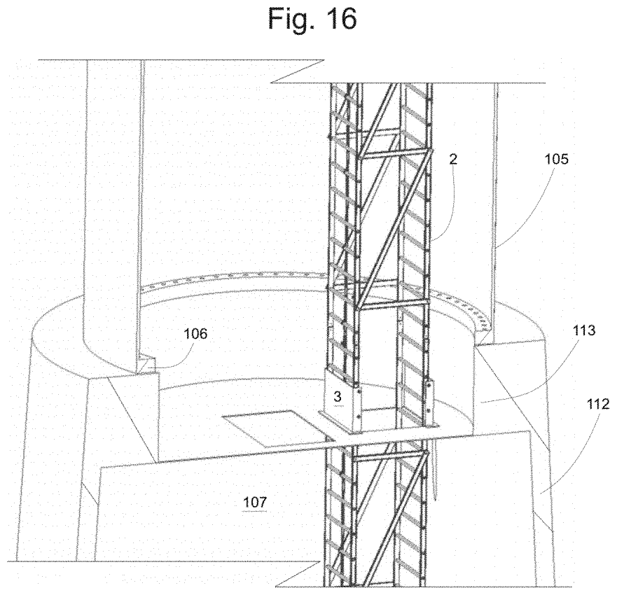

The tower 101 may comprise a second tower section 112, wherein the second tower section 112 may be joined to the first tower section 105 at flanges 106, 113, see for instance FIG. 16.

As can be seen in FIGS. 2 and 3, the upper flange 113 and the lower flange 106 are respectively provided at opposite ends of the tower section 105. In one example, the mast 2 may be supported by the upper and the lower flange 113, 106.

In further examples, the tower section 105 may comprise a service platform 4, and the mast 2 may be at least partially supported by the service platform 4. In the attached FIGS. 2, 4, 7, an example can be seen wherein the mast is partially supported by the service platform 4.

The tower may comprise a service platform supported by the upper or the lower flange.

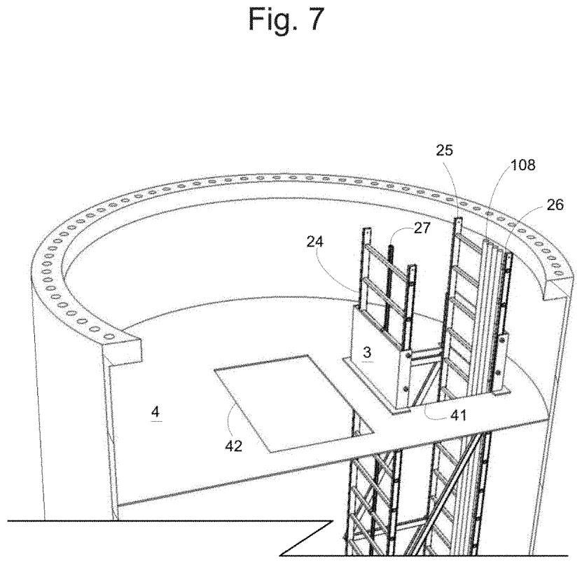

The platform 4 may comprise a mast opening 41 where the mast 2 may pass through. In FIG. 7, an example of the mast opening 41 is clearly shown.

In the examples of FIGS. 2, 4, 7, the service platform 4 is positioned in a cavity 107 defined by the inner side of tower walls 114 along the length of the tower 101. Further in FIGS. 2, 4, 7 an example can be seen wherein the mast 2 is connected to the platform 4 in such a way that at least a portion of the mast 2 may hang from the platform 4 in use.

In some non-illustrated examples, the service platform 4 may be supported by the upper or the lower flange 113, 106. Alternatively, the service platform 4 may be attached to the tower wall 114.

In further examples, the platform 4 may be positioned substantially at the top of the tower 101 and a flange to which the mast 2 may be connected may be positioned substantially at the bottom of the tower. The flange to which the mast is connected does not necessarily belong to the same tower section in which the platform is located. For instance, in an example not illustrated the mast may be connected both to the platform of an uppermost section of the tower and to a flange of a lowermost section of the tower.

In the examples of FIGS. 2 and 3, the platform 4 is positioned substantially at the top of a tower section 105 and the mast 2 is connected to the lower flange 106 positioned substantially at the bottom of the tower section 105.

As can be seen in FIGS. 2 and 3, the flanges 106, 113 are disposed inside the cavity 107.

In some examples, the tower 101 may further comprise a number of brackets 3 to support the mast 2 to the service platform 4, wherein a bracket 3 may comprise a body configured to surround, at least partially, the cross section of the ladder 24, 25. The latter can be seen in FIG. 7 where it also shows that the brackets 3 are provided at the top of the platform 3, particularly connected to each ladder 24, 25. The brackets 3 may carry vertical loads from the ladder 24, 25 and transmit the loads to platform 4 and to the tower section 105 (see e.g. FIG. 2). Therefore, the lowest module 21 of the mast does not have to withstand with all the weight of mast 2.

The example of bracket 3 illustrated in FIG. 7 comprises a body with a generally U-shaped cross-section to embrace at least partially a ladder 24, 25.

In the example of FIGS. 2, 3, and 4, the mast 2 comprises a plurality of mast modules 21 stacked on top of each other and/or assembled with each other. An example of module 21 will be explained in conjunction with FIG. 6A-6G wherein the mast 2 comprises a first longitudinal ladder beam 24, a second longitudinal ladder beam 25, and braces 22, 23 connecting the first and second ladder beams 24, 25.

The ladder beams may be considered as ladders.

The braces 22, 23 may be pivotally joined to the ladder beams 24, 25 in such a way that the ladder beams 24, 25 are movable relative to each other. The latter can be seen for instance in FIGS. 6A-6G. FIGS. 6A-6G schematically illustrate several positions of a module 21 of the mast 2 according to an example from an expanded or a deployed configuration to a folded configuration.

An expanded configuration of the module 21 may refer to the configuration where the ladder beams 24, 25 are separated most from each other, and the folded configuration may refer to the configuration where the ladder beams 24, 25 are closest together. FIG. 6A is an example of a module 21 in an expanded (or “unfolded”) configuration and FIGS. 6F, 6G show examples of a module 21 in a folded configuration.

Starting from FIG. 6A, oblique braces 22 may be rotated following direction A1 and A2 in FIG. 6B. The oblique braces 22 are loose at one end in this situation so as to allow the rotation thereof. In use, the oblique braces may be fixed at this end to ladder beam 25. Directions A1, A2 may be clockwise or counter-clockwise. When the oblique braces 22 have reached an end position as per FIG. 6C, the ladder beam 24, 25 may start to move closer to each other. The relative approach between ladder beams 24, 25 may be guided by the perpendicular braces 23 which are rotatably or pivotally joined to the frameworks. Suitable hinges may be provided.

The approach may follow a rotation which comprises two components: one vertical and one horizontal component. The ladder beams 24, 25 may reach a configuration where the ladder beams 24, 25 are horizontally brought together and vertically displaced relatively to each other, see for instance FIGS. 6F and 6G.

The hereinbefore described procedure relates to an example of a folding process. An unfolding or expanding process may be obtained following the same steps conversely. In use, the braces may be substantially locked in the deployed configuration.

The braces 22, 23 may join the ladder beams 24, 25 in such a way that the module 21 has a quadrangle-shaped cross-section in use, particularly in an expanded configuration. A straight and vertical path for operators may be defined by the braces and the ladder beams 24, 25 when the module 21 is in an expanded configuration. An operator O may climb or descend along the path of the mast 2 as can be seen in FIGS. 2-5, i.e. internally of the mast.

By way of non-limiting example, the cross-section of module 21 may be about 800×800 mm and therefore a ladder beam may have a width of about 800 mm. Braces 22, 23 and ladder beams 24, 25 may be made from steel and/or aluminum and/or composite.

In further examples as that one illustrated in FIG. 7, the ladder beam 24, 25 may comprise a holding portion 26 for cables 108 routing in the longitudinal direction of the mast 2. The holding portion 26 may be a ladder beam section acting as a tray.

Also in FIG. 7, it can be seen that the ladder beam 24, 25 may comprise a rail 27 (see for instance FIG. 7) and/or a lifeline. A rigid rail 27 or a flexible lifeline may be positioned on the ladder beam 24, 25 in such a way that they are not hindered by the brackets 3. Thus, an operator O may use the rail or the lifeline in spite of the brackets 3.

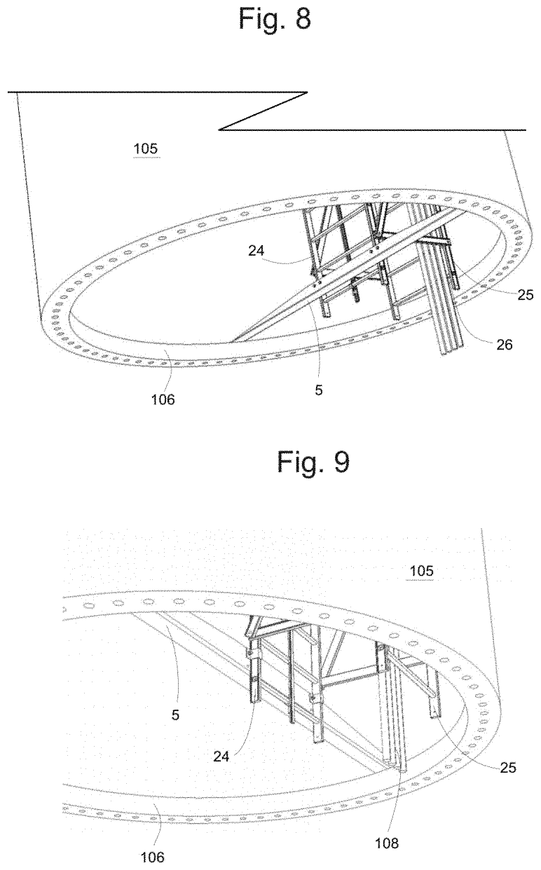

FIG. 8 schematically illustrates a partial view of a mast 2 and a support beam 5 of FIG. 2. FIG. 9 schematically illustrates a partial view of a mast 2 and a support beam 5 of FIG. 8 from a different perspective.

In the example of FIGS. 8 and 9, the tower 101 further comprises a support beam 5 for the mast 2, wherein the support beam 5 may be transversely disposed to a tower section 105, 112 and may be detachably joined to a flange 106, 113, e.g. on diametrically opposite sides of the flange, and to the mast 2. The portion of the mast 2 of a section 105, 112 may be kept fixed at both ends of the sections 105, 112 by means of the support beam 5 and a link to a flange 106, 113, e.g. the bracket 3 coupling the mast 2 to the platform 4. The support beam 5 may be joined to either the upper flange 113 or the lower flange 106.

The support beam 5 may be attached to transportable tower sections 105, 112 such as those made from steel or the like. The support beam 5 may be a temporary toolkit to assist the operators during transportation and mounting tasks as will be explained later on.

In some examples, the tower 101 may further comprise a service elevator associated with the mast, wherein an elevator cabin 110 may run laterally to the mast 2 and in the same or substantially the same direction as the length of the mast 2. Laterally herein should be understood as an elevator path outside the space defined by the mast 2, and in the depicted example, the space defined between by ladder beams 24, 25 and the braces 22, 23.

The elevator, and particularly the elevator cabin 110, may be arranged relative to the mast 2 in different ways. By way of examples, FIGS. 5A-5C schematically illustrate cross-sectional views of a tower section 105, 112 with different relative arrangements of mast 2 and elevator cabin 110. The examples of FIGS. 5A-5C are only some possible arrangements it should be clear that many other arrangements are possible.

The elevator may follow an elevator path through an elevator opening 42 in the platform as can be seen in FIG. 7.

In some examples, the mast 2 may comprise an arm 28 with a wirefix 29 (see e.g. FIG. 2) to secure a guiding wire 109 of a service elevator. In FIG. 2, the mast 2 comprises a pair of lateral arms 28 with respective wirefixes 29 to the elevator cabin 110. The arms 28 may be attached to the ladder beams 24, 25.

In some examples, guiding wires 111 of the elevator might be used as stability elements for restraining horizontal movements of the mast 2. However, in some other examples, the arrangement of the mast 2 connected both to the platform 4 and a flange 106, 113 may adequately restrain the mast 1 without any auxiliary elements.

In some further examples, additional wires (not illustrated) to specifically restrain the mast 2 with respect to the tower 101 may be provided.

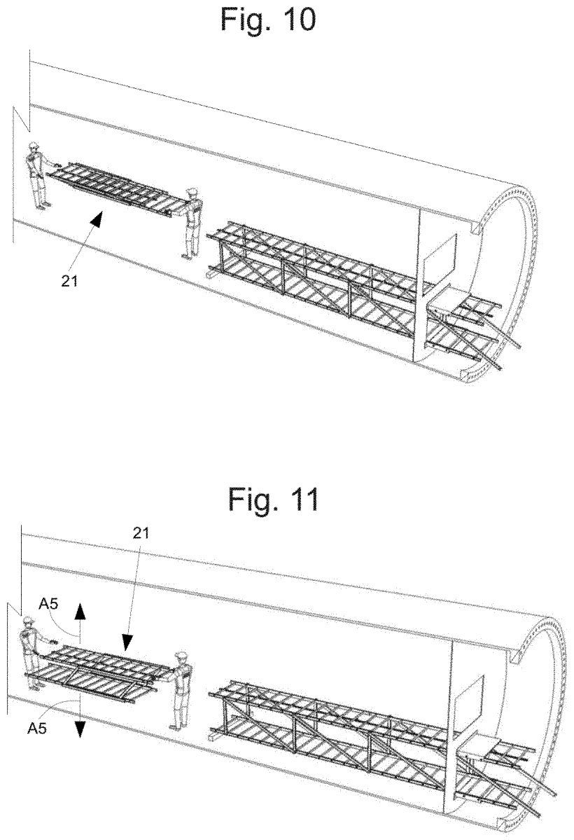

According to a further aspect, a method for installing a mast 2 on a tower 101 according to any of herein disclosed examples is provided. The method will be explained in conjunction with FIGS. 10-16. The method comprises assembling a number of mast modules 21 one after the other. See for instance FIGS. 10-14 wherein the modules 21 are being assembled manually. Then the mast 2 may be connected to an upper or lower flange 106, 113 of the tower 101.

Alternatively, one end of the mast 2, such as a top end, may be connected to a platform 4 of the tower 101 and the other end of the mast 2, such as a bottom end, may be connected to a lower flange 106 of the tower 101. The platform 4 may be installed in and mounted to the tower 101 beforehand.

In one example of the tower, the mast may be connected to the tower section only through the upper and lower flanges, so that the mast is not attached to the tower wall. In another example of the tower, the mast may be connected to the tower section only through the service platform and the lower flange, so that the mast is not attached to the tower wall. In both examples, the tower may be devoid of intermediate connections between the mast and the tower wall in an area defined substantially along the inner wall of the tower and from the upper to the lower flanges or from the service platform to one of the upper and lower flanges.

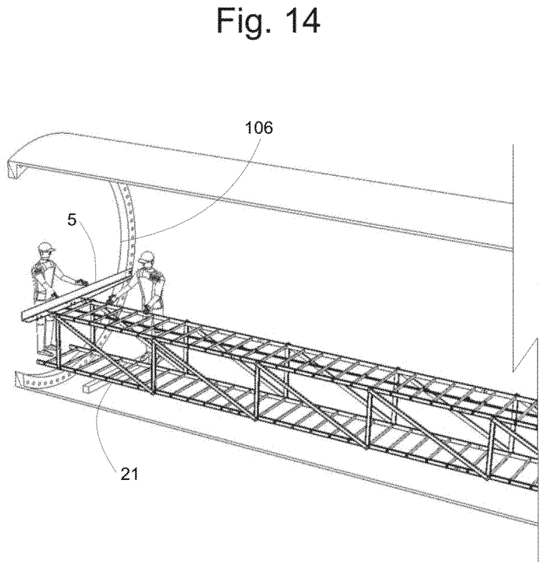

FIGS. 10-14 schematically illustrate several steps for installing a portion of mast 2 in a tower section 105 according to an example. This example corresponds to a case where the section 105 may be transportable, e.g. made from steel. In that case, the method may further comprise providing a tower section 105 in a horizontal arrangement. This horizontal arrangement may be substantially perpendicular to the length of the tower 101 when erected, and the tower section 105 may be laid on the ground. Then, a support beam 5 may be coupled to the flange 106 in a detachable way. Afterwards, a mast module 21 may be coupled to the support beam in a detachable way. The module 21 may be joined with the beam 5 particularly through a ladder beam 24, 25. In FIG. 14, it can be seen an exemplary way to detachably couple the support beam 5 to the lower flange 106 and to the module 21.

The support beam 5 may be installed in a tower factory and used during handling, transportation and elevation operations. The beam may be removed after erection of the tower. Before uninstalling the beam 5, an upper module 21 may be connected to a lower module 21 which may be integrated in a previously erected tower section 105, thereby creating structural continuity between modules 21. The support beam 5 may be considered therefore as a kind of “transportation toolkit”.

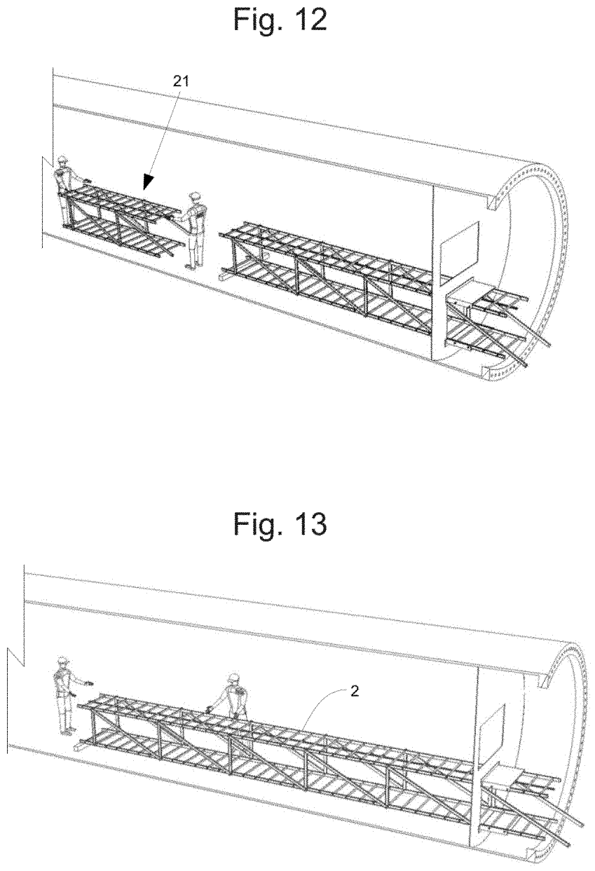

In the examples wherein the module 21 is foldable, the method may further comprise introducing a mast module 21 into the tower section 105 when the module 105 is in a folded configuration. This can be seen, for instance in FIG. 10. Then the module may be unfolded. The ladder beams 24, 25 may be moved away from each other so that the mast module may adopt an expanded configuration. This can be seen, for instance in FIGS. 11 and 12. Arrows A5 in FIG. 11 illustrate directions followed by ladder beams 24, 25 when moving apart from each other. The expanding or unfolding process may be the same as hereinbefore described.

Alternatively, the modules 21 may be introduced into the section 105 in an expanded configuration. The modules may then be attached to each other such that, when the tower is erected, the modules are stacked on top of each other.

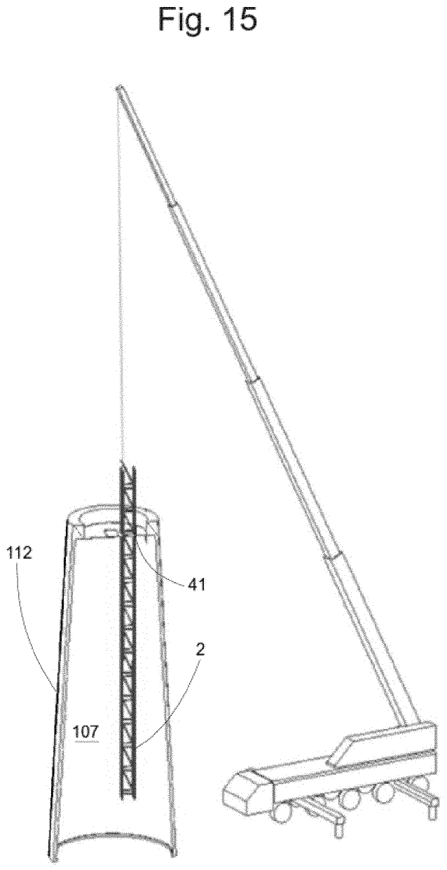

FIG. 15 schematically illustrates a mast 2 being introduced into a tower section 112 according to a further example, particularly suitable for concrete tower sections. The method according to this example may further comprise providing a tower section 112 in an erected arrangement and introducing a number of assembled mast modules 21 into the cavity 107 of the tower section 112. The modules 21 may be assembled on the ground and then hoisted. The modules 21 may be introduced through the mast opening 41 of the platform. Afterwards, the mast 2 may be connected to the platform 4 by means of the brackets 3.

FIG. 16 schematically illustrates a partial view of a mast 2 disposed through two different tower sections 105, 112 according to yet another example. The section 105 on the top side of FIG. 16 may be portable, made for instance from steel, and the section 112 on the bottom side of FIG. 16 may be not portable, made for instance from concrete. In the example of FIG. 16, a concrete section 112 may be provided in an erected arrangement. A batch of assembled mast modules 21 may be connected to the platform 4 as above mentioned. Then a steel section 105 with another batch of already assembled mast modules 21 may be arranged on top of the concrete section 112. The lowest module 21 of the steel section 105 may be attached to the uppermost module 21 of the concrete section 112. The support beam 5 of the steel section 105 may be then removed. In the example of FIG. 16 the top of the mast 2 may be connected to another upper platform 4.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow. If reference signs related to drawings are placed in parentheses in a claim, they are solely for attempting to increase the intelligibility of the claim, and shall not be construed as limiting the scope of the claim.

For reasons of completeness, various aspects of the invention are set out in the following numbered clauses:

Clause 1. A tower comprising:
a first tower section having an upper flange, and a lower flange, a tower wall; and
a mast, wherein the mast comprises a ladder; and
the mast is not attached to the tower wall.

Clause 2. The tower according to clause 1, wherein the mast is supported by the upper and the lower flange.

Clause 3. The tower according to clauses 1-2, wherein the tower section comprises a service platform, and wherein the mast is at least partially supported by the service platform.

Clause 4. The tower according to clause 3, wherein the service platform is supported by the upper or the lower flange.

Clause 5. The tower according to clause 3, further comprises a number of brackets to support the mast to the service platform, wherein a bracket comprises a body configured to surround, at least partially, the cross section of the ladder.

Clause 6. The tower according to any of clauses 1-5, wherein the tower comprises a second tower section, wherein the second tower section is joined to the first tower section at flanges.

Clause 7. The tower according to any of clauses 1-6, wherein the mast comprises a plurality of mast modules stacked on top of each other or assembled with each other.

Clause 8. The tower according to any of clauses 1-7, wherein the mast comprises a first longitudinal ladder beam, a second longitudinal ladder beam, and braces connecting the first and second ladder beams.

Clause 9. The tower according to clause 8, wherein the braces are pivotally joined to the ladder beams in such a way that the ladder beams are movable relative to each other.

Clause 10. The tower according to any of clauses 1-9, further comprising a support beam for the mast, wherein the support beam is transversely disposed to a tower section and is detachably joined to a flange and the mast.

Clause 11. The tower according to clause 10, further comprising a service elevator associated with the mast, wherein an elevator cabin runs laterally to the mast and in the same direction as the length of the mast.

Clause 12. A method for installing a mast on a tower according to any of clauses 1-11, comprising:
assembling a number of mast modules one after the other;
connecting the mast to an upper or lower flange of the tower.

Clause 13. The method according to clause 12, wherein the tower section is made from steel, the method further comprising:
providing a tower section in a horizontal arrangement;
detachably coupling a support beam with a flange;
detachably coupling a mast module with the support beam.

Clause 14. The method according to clause 13, further comprising:
introducing a mast module into the tower section when the module is in a folded configuration;
moving away the ladder beams from each other so that the mast module adopts an expanded configuration.

Clause 15. The method according to clause 12, wherein the tower section is made from concrete, the method further comprising:
providing a tower section in an erected arrangement;
introducing a number of assembled mast modules into the cavity of the tower section.

1. A tower comprising:
a first tower section having an upper flange, a lower flange, and a tower wall; and
a mast, wherein the mast comprises a ladder; and
the mast comprises a top end and a bottom end, the top end being connected to the upper flange or a service platform, and the bottom end being connected to the lower flange, so that the mast is not attached to the tower wall.

2. The tower according to claim 1, wherein the tower comprises a second tower section, wherein the second tower section is joined to the first tower section at flanges.

3. The tower according to claim 1, wherein the mast comprises a plurality of mast modules stacked on top of each other or assembled with each other.

4. The tower according to claim 1, wherein the tower comprises a service platform supported by the upper or the lower flange.

5. The tower according to claim 1, further comprises a number of brackets to support the mast to the service platform, wherein a bracket comprises a body configured to surround, at least partially, the cross section of the ladder.

6. The tower according to claim 1, wherein the mast comprises a first longitudinal ladder beam, a second longitudinal ladder beam, and braces connecting the first and second ladder beams.

7. The tower according to claim 6, wherein the braces are pivotally joined to the ladder beams in such a way that the ladder beams are movable relative to each other.

8. The tower according to claim 1, further comprising a support beam for the mast, wherein the support beam is transversely disposed to a tower section and is detachably joined to a flange and the mast.

9. The tower according to claim 1, further comprising a service elevator associated with the mast, wherein an elevator cabin runs laterally to the mast and in the same direction as the length of the mast.

10. The tower according to claim 1, wherein the mast is connected to the tower section only through the upper and lower flanges.

11. The tower according to claim 1, wherein the mast is connected to the tower section only through the service platform and the lower flange.

12. A method for installing a mast on a tower, the tower comprising:
a first tower section having an upper flange, a lower flange, and a tower wall; and
a mast, wherein the mast comprises a ladder; and
the mast comprises a top end and a bottom end, the top end being connected to the upper flange or a service platform, and the bottom end being connected to the lower flange, so that the mast is not attached to the tower wall;
the method comprising:
assembling a number of mast modules one after the other;
connecting a top end of the mast to an upper flange or a service platform and a bottom end of the mast to a lower flange of the tower section.

13. The method according to claim 12, wherein the tower section is made from steel, the method further comprising:
providing a tower section in a horizontal arrangement;
detachably coupling a support beam with a flange;
detachably coupling a mast module with the support beam.

14. The method according to claim 13, further comprising:
introducing a mast module into the tower section when the module is in a folded configuration;
moving away the ladder beams from each other so that the mast module adopts an expanded configuration.

15. The method according to claim 12, wherein the tower section is made from concrete, the method further comprising:
providing a tower section in an erected arrangement;
introducing a number of assembled mast modules into the cavity of the tower section.

16. A tower comprising:
a first tower section having an upper flange, and a lower flange, a tower wall; and
a mast, wherein the mast comprises a ladder;
the mast is not attached to the tower wall;
the mast comprising a first longitudinal ladder beam, a second longitudinal ladder beam, and braces connecting the first and second ladder beams;
the braces being pivotally joined to the ladder beams in such a way that the ladder beams are movable relative to each other.
